(19) United States
(12) Patent Application Publication
(10) Pub. No.: US 2009/0123636 A1
(43) Pub. Date: May 14, 2009

(54) Food Composition

(76) Inventors: Young Martin de Graaf, Vlaardingen (NL); Karel Hrncirik, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/083,856

(22) PCT Filed: Sep. 19, 2006
(86) PCT No.: PCT/EP2006/009123

§ 371 Date: Apr. 18, 2008

(30) Foreign Application Priority Data
Oct. 25, 2005 (EP) 05077454.5

(51) Int. Cl. A23L 1/28

(52) U.S. Cl. 426/655

(57) ABSTRACT

A fluid wine extract comprising: (a) from 4.0 to 10.0 wt % of ethanol; preferably from 5.0 to 9.0 wt %, most preferred from 6.0.0 wt % to 8.0 wt %, (b) from 20 to 70 wt % of wine solids, more preferred from 25 to 65 wt %, most preferred from 30 to 60 wt %, (c) from 26 to 75 wt % of water, more preferred from 37.5 to 65 wt %, most preferred from 45 to 55 wt %, said wine extract having a pH of between 1.5 and 5.0 more preferred from 2.0 to 4.5, most preferred from 2.6 to 4.0.

### FIELD OF THE INVENTION

The invention relates to a food composition, specifically to a functional food composition having one or more health effects in humans. In particular, such health effect is related to a decreased risk of cardiovascular disorders.

### BACKGROUND TO THE INVENTION

Polyphenolic compounds (hereinafter polyphenols) enjoy a considerable scientific interest for their health promoting properties. Epidemological studies have shown that consumption of foods rich in polyphenols is associated with a lower incidence of cardiovascular disorders.

Since polyphenols are widespread among plants and plant products, polyphenols are naturally present in many foods including fruits, vegetables, fruit drinks, in varying amounts.

A number of studies in the prior art were directed to red grape products, such as red grape juice and red wine.

Well-known is the so-called ‘French paradox’. The paradox is the low cardiovascular mortality rate observed in Mediterranean populations in association with red wine consumption despite a high saturated fat intake. Not only laymen, but also many scientists are willing to accept that such a relation really exist (de Lorgeril, 2002; Belleville, 2002; Sun, 2002; Renaud, 1992).

Effects of grape products on various cardiovascular health markers, including blood pressure, platelet function and plasma lipid profiles, have been evaluated in a number of human trials. A particular red grape juice (Welch's, Concord, Mass.) seems to reduce platelet aggregation in healthy subjects, although a proper placebo control was lacking in these studies (Freedman, 2001). Data on red wine are confusing: platelet aggregation is reduced in subjects after 15 days consumption of red wine compared to after white wine consumption (Pignatelli, 2002), but when the red wine is de-alcoholized no effect is observed anymore (Pellegrini, 1996). The alcohol may thus be a major contributor to the inhibition of platelet aggregation. Reported effects on plasma lipid profiles by grape products ate also in contradiction. Total and LDL-cholesterol plasma levels are usually not affected by grape juice (O'Byrne, 2002), grape seed extract (Vigna, 2003), red wine extract (Chopra, 2000) or red wine (Cordain, 2000), but in several studies HDL increased after red wine consumption (Van der Gaag, 2001; Gottrand, 1999; Goldberg, 1996). This effect may, however, well be attributed to the alcohol content in the wine, because other alcohol-containing beverages induced similar effects on HDL (Van der Gaag, 2001), and de-alcoholized red wine extract was ineffective in this respect (Chopra, 2000). In one human trial a moderate total- and LDL-cholesterol reduction was observed after consumption of red wine, but a proper no-alcohol containing placebo control was missing in this study (Cartron, 2003). Beneficial effects on blood pressure are rarely reported. Chronic consumption of red wine seems not to affect blood pressure (Cordain, 2000), but acute blood pressure lowering effects may occur, due to the alcohol content (Mahmud, 2002). However, a specific subpopulation may benefit from drinking red grape juice (Welch's). Systolic blood pressure reduced in those subjects with above 132 mmHg values. On the other hand, the diastolic blood pressure increased in subjects with optimal blood pressure values (Mark, 2003). The data summarised here should be interpreted with care. Often other components than the polyphenols may be responsible for the effects observed, such as the alcohol in wine and the high sugar content or the added vitamin C in (Welch's) grape juice. Welch's grape Juice® is commercially available. Welch's grape Juice® is not available in the form of a powdered extract.

For the application in functional food products, grape juice and red wine are less suitable, since in juice and wine the concentration of polyphenols is relatively low. Also, when juice or red wine are added to a functional food composition, there may be product components introduced into the food that are not desirable, such as alcohol and sugar.

Dozens of different dry or aqueous grape and wine extracts are commercially available, the extracts include grape extract, wine extract, skin- and/or seed extract. However most of these extracts are not suitable for application in a functional food, since they are either difficult to handle or they suffer from sedimentation or precipitation, also they sometimes contain too low levels of solid material.

EP-B-930831 describes a plant-derived flavonol-containing dry composition obtained from grapes, wine or flavonol-containing by-products or waste-products of wine making having a high polyphenol content, preferably at least 45% polyphenols. The dry composition is suitable for reducing the risk of cardiovascular disease. In particular, the composition has the effect of inhibiting oxidation of plasma LDL, stimulation of TGF-β production, inhibiting platelet aggregation and stimulating fibrinolysis. The dry composition is used as a medicament or as food supplement. In the examples red wine extract is used. We have found that when such a dry red wine extract is used as ingredient for a functional food product the processing of the product often is difficult.

US2003/0064970 describes a lyophilized red wine or white wine, reconstituted in one tenth volume of 5% ethanol in water to produce a ten fold wine concentrate. The concentrates have a low solid content, low ethanol content and relative high water content.

FR-2 791 696 describes a method to obtain a dry red wine extract with a decreased acidity.

The abstract of SU1833420 describes a wine concentrate obtained by distilling the alcohol off at 70-80° C. followed by concentrating the residue to 15-25% of its initial volume and then adding 8-12 vol % of distilled alcohol. The concentrates have a low solid content and relative high water content.

Until today no fluid ingredient, originating from wine or grape, suitable for incorporation in a functional food product is known, that results in a functional food product that can easily be prepared, does not suffer from precipitation or sedimentation and is adequately efficacious in decreasing risk of cardiovascular disorders, specifically reduction of hypertension, inhibition of platelet aggregation, reduction of level of total blood cholesterol and/or reduction of level of LDL cholesterol.

### SUMMARY OF THE INVENTION

It is therefore an object of the invention to provide a fluid wine extract having one or more health effects in humans, in particular such health effect is related to a decreased risk of cardiovascular disorders. Another object is to provide a fluid wine extract which is easy to handle, does not suffer from precipitation or sedimentation and still contains the desired level of active ingredients. In addition, a further object is to provide a fluid wine extract that may be incorporated at such level into a food product that it gives health benefits but a minimum amount of alcohol. Another object is to provide a food composition comprising said wine extract at the desired level without suffering from sedimentation or other problems. Still a further object is to provide a food composition, that upon consumption by a human subject is effective in causing in the human subject one or more, preferably two or more, more preferably three or more and most preferably all four of the following effects: reduction of hypertension, inhibition of platelet aggregation, reduction of level of total blood cholesterol and/or reduction of level of LDL cholesterol.

One or more of these objects are attained according to the invention in a fluid wine extract of specific composition or in a food composition comprising said wine extract.

Accordingly in a first aspect, the invention relates to a fluid wine extract comprising:
(a) from 4.0 to 10.0 wt % of ethanol; preferably from 5.0 to 9.0 wt %, most preferred from 6.0 wt % to 8.0 wt %.
(b) from 20 to 70 wt % of wine solids, more preferred from 25 to 65 wt %, most preferred from 30 to 60 wt %.
(c) from 26 to 75 wt % of water, more preferred from 37.5 to 65 wt %, most preferred from 45 to 55 wt %.
   said wine extract having a pH of between 1.5 and 5.0 more preferred from 2.0 to 4.5, most preferred from 2.6 to 4.0.

Surprisingly it has been found that high levels of wine solids can be incorporated into a fluid extract composition without unduly affecting the solubility properties, provided that the level of ethanol in the extract and the pH of the extract is carefully controlled. For the purpose of the invention the term fluid extract relates to non-dry composition which are not form-stable and which may easily be deformed. Fluid compositions may be liquid to pasty such that it still can be easily dosed through a nozzle.

The amount of ethanol in the fluid extract is from 4.0 to 10 wt % preferably from 5 to 9 wt %, most preferred from 6 wt % to 8 wt %.

For the purpose of the invention the term wine solids refer to the solid mixture of ingredients that remains after removing the water and alcohol part of wine. Preferably wine solids from red wine are used. These red wine solids normally contain high levels of several polyphenols.

The level of wine solids in the fluid extract is from 20 to 70 wt % more preferred from 25 to 65 wt %, most preferred from 30 to 60 wt %. Wine solids normally predominantly comprise a mixture of polyphenols; therefore for the purpose of the invention fluid wine extracts preferably comprise 20 to 70 wt % of polyphenols, more preferred from 25 to 65 wt %, most preferred from 30 to 60 wt %.

Preferably the fluid wine extract of the invention comprises no or only low levels of ingredients other than ethanol, wine solids and water. Preferably the level of these other ingredients is less than 3 wt %, more preferred from 0 to 1 wt %, most preferred from 0.01 to 0.5 wt %. An example of a suitable other ingredient is a pH regulator which is preferably an edible acid material such as citric acid. Such a pH regulator is preferably added in such amounts that the pH of the fluid extract is between 1.5 and 5.0 more preferred from 2.0 to 4.5, most preferred from 2.6 to 4.0.

The fluid wine extract of the invention may be added to food products, preferably the amount of wine extract is 0.1 to 10 grams per kg of product, more preferred from 0.15 to 5 grams per kg of product, most preferred from 0.25 to 3 gram per kg of product. Also preferably the amount of extract added to the food product of the invention is preferably chosen such that 1 kg of product contains 0.5 to 2.5 grams of wine polyphenols, more preferred from 1.0 to 2.0 grams of wine polyphenols.

Accordingly in another aspect the invention relates to a food composition comprising 0.1 to 10 grams of wine extract per kg of product, more preferred from 0.15 to 5 grams wine extract per kg of product, most preferred from 0.25 to 3 gram wine extract per kg of product, wherein the wine extract is the fluid wine extract as described here-above.

In another aspect the invention relates to a method to prepare a food product comprising the step of incorporating into the food product from 0.1 to 10 grams of wine extract, more preferred 0.15 to 5 grams wine extract per kg of product, most preferred from 0.25 to 3 gram wine extract per kg of product, wherein the wine extract is the fluid wine extract as described here-above.

The food composition according to the invention may preferably be used as a physiologically functional food product. According to a preferred embodiment, the consumption of the food composition by a human subject is effective in causing in the human subject one or more, preferably two or more, more preferably three or more and most preferably all four of the following effects:

a) reduction of hypertension;
b) inhibition of platelet aggregation;
c) reduction of level of total blood cholesterol;
d) reduction of level of LDL cholesterol.

The amount of polyphenols in the food composition may be any amount that is effective in a health effect in a human, when consumed in an ordinary way. Preferably, the amount of polyphenols in the food composition is such that the amount of polyphenols in an average serving of the food composition is 150 mg or more, more preferably 300 mg or more, even more preferably 500 mg to 2000 mg. The average serving size for a food product according to the invention may be indicated herein. Alternatively, for food products of which the average serving size is not given herein, average serving size is defined as the “reference amounts of food customarily eaten at one time” found in the Food Nutrition Tables of the Food and Drug Administration (USA).

The food products according to the invention may be of any food type. They may comprise common food ingredients such as flavour, sugar, fruits, minerals, vitamins, stabilisers, thickeners, etc. in appropriate amounts. Preferably the food products are fruit juice products, margarine, spreads and dairy type products or frozen confectionery products. These preferred types of food products are described in some detail below and in the examples. These preferred food products may advantageously be used as part of a fat containing meal, or be used in conjunction with such a meal.

### Examples of Food Products According to the Invention are:

Fruit Juice Products

Examples of fruit juice products according to the invention are juices derived from citrus fruit like orange and grapefruit, tropical fruits, banana, peach, peer, apple, strawberry or berry in which the wine extract dissolved or suspended. The average serving size for the fruit juice products is 250 ml.

Dairy Type Products

Examples of dairy products according to the invention are milk, margarines, dairy spreads, cream cheese, milk type drinks and yoghurt, wherein the wine extract are dissolved or suspended. Optionally flavour or other additives may be added.

An example of a composition for a yoghurt type product is about 50-80 wt. % water, 0.1-15 wt. % hydrolysed casein solids, 0-15 wt. % whey powder, 0-15 wt. % sugar (e.g. sucrose), 0.01-1 wt. % yoghurt culture, 0-20 wt. % fruit, 0.05-5 wt. % vitamins and minerals, 0-2 wt. % flavour, 0-5 wt. % stabilizer (thickener or gelling agent).

An average serving size for a yoghurt type product could be from 50 to 250 g, generally from 80 to 200 g.

Frozen Confectionery Products

For the purpose of the invention the term frozen confectionery product includes milk containing frozen confections such as ice-cream, frozen yoghurt, sherbet, sorbet, ice milk and frozen custard, water-ices, granitas and frozen fruit purees.

Preferably the level of solids in the frozen confection (e.g. sugar, fat, flavouring, etc) is more than 3 wt. %, more preferred from 10 to 70 wt. %, for example 40 to 70 wt. %.

Ice cream will typically comprise 0 to 20 wt. % of fat, 0.1 to 5 wt. % wine extract, 0.1 to 5 wt. % grape juice, sweeteners, 0 to 10 wt. % of non-fat milk components and optional components such as emulsifiers, stabilisers, preservatives, flavouring ingredients, vitamins, minerals, etc, the balance being water. Typically ice cream will be aerated e.g. to an overrun of 20 to 400%, more specific 40 to 200% and frozen to a temperature of from −2 to −200° C., more specific −10 to −30° C. Ice cream normally comprises calcium at a level of about 0.1 wt %.

The average serving size of a frozen confectionery product is 85 g.

Nutrition Bars

As example a composition of a granola bar is given. Granola bars consists of a binder syrup which binds the granola and fruit ingredients into a solid bar. E.g. nuts, pieces of chocolate, or a low moisture yoghurt filling can be added as well. The bar can be enrobed with a coating of e.g. chocolate or a low moisture yoghurt layer. The average serving size is typically 60 grams.

### Granola Bar Example (Weight Per Cent)

0-40% granola base (oat flakes, wheat flakes, rice crispies)
0-60% binder syrup (corn syrup, sugar, salt, lecithin, vegetable oil)
0-40% fruit filling (low moisture jelly, dried fruits)

Moisture content is typically below 15%.

More detailed composition:
Oat flakes/wheat flakes 0-25%
Rice crispies 0-15%
Corn syrup 0-50%

### Sugar-O-15%

### Lecithin 0-1%

### Salt 0-1%

### Vegetable oil 0-25%

Dried fruits 0-20%
Low moisture fruit jelly 0-20%

### Stabilisers 0-2%

Stabilisers are often added to create a more solid fruit filling.

### Flavours 0-2%

### Vitamins/minerals 0-5%

Products are ambient stable.

Food Emulsions, (Fruit) Spreads

The food product may be an oil and water containing emulsion, for instance a spread. Oil and water emulsion is herein defined as an emulsion comprising oil and water and includes oil in water (O/W) emulsions and water in oil emulsions (W/O) and more complex emulsions for instance water-in-oil-in-water (W/o/W/O/W) emulsions. Oil is herein defined as including fat.

Preferably the food product is a spread, frozen confection, or sauce. Preferably a spread according to the invention comprises 30-90 wt. % vegetable oil. Advantageously a spread has a pH of 4.2-6.0.

Other food product according to the invention can be prepared by the skilled person based on common general knowledge, using the wine extract as an ingredient in suitable amounts. Examples of such food products are baked goods, dairy type foods, snacks, etc.

### EXAMPLES

Wine extracts were prepared by first removing the alcohol from red wine by distillation, followed by concentration of the resulting liquid under reduced pressure till the desired level of solids was obtained and addition of citric acid and ethanol in the amounts as specified.

The following fluid compositions were made:

| Ingredient | | | | | | | | | | |
|---|---|---|---|---|---|---|---|---|---|---|
| (parts by | | | | | | | | | | |
| weight) | A | B | C | D | E | F | G | H | I | J |
| Wine solids | 200 | 100 | 50 | 25 | 12.5 | 6.25 | 625 | 300 | 500 | 250 |
| Ethanol | 39.5 | 39.5 | 39.5 | 39.5 | 39.5 | 39.5 | 79 | 79 | 63 | 63 |
| Citric acid | 1 | 1 | 1 | 1 | 1 | 1 | 1 | 1 | 1 | 1 |
| water | 960.5 | 960.5 | 960.5 | 960.5 | 960.5 | 960.5 | 900 | 900 | 900 | 900 |
| pH | 3.1 | 3.1 | 3.1 | 3.1 | 3.1 | 3.1 | 3.1 | 3.1 | 3.1 | 3.1 |
| Appearance | − | − | − | − | − | − | ++ | ++ | ++ | ++ |

− indicates some precipitation/sedimentation resulting in a slightly turbid appearance.
++ indicates completely clear without precipitation/sedimentation

### Example II

A flavoured transparent, clear mineral water was mixed with the fluid extract of examples A-J in an amount of 0.4 grams of fluid extract per 100 mls of mineral water. The result was that the products made with extracts A-F still showed turbidity, while the products made with G-J did not show turbidity and had an attractive pink colour.

A flavoured yoghurt drink was prepared by mixing a liquid yoghurt drink with 0.4 grams of the fluid extract of examples A-J in per 100 mls of yoghurt. The result was that products made with the extracts A-F had a unattractive brownish appearance possibly caused by precipitation/sedimentation of the wine solids while the products made with fluid extracts G-J had an attractive pink appearance.

1. A fluid wine extract comprising:
(a) from 4.0 to 10.0 wt % of ethanol; preferably from 5.0 to 9.0 wt %, most preferred from 6.0 wt % to 8.0 wt %.
(b) from 20 to 70 wt % of wine solids, more preferred from 25 to 65 wt %, most preferred from 30 to 60 wt %.
(c) from 26 to 75 wt % of water, more preferred from 37.5 to 65 wt %, most preferred from 45 to 55 wt %.
said wine extract having a pH of between 1.5 and 5.0 more preferred from 2.0 to 4.5, most preferred from 2.6 to 4.0.

2. A method to prepare a food product comprising the step of incorporating into the food product from 0.1 to 10 grams per kg of fluid wine extract, more preferred 0.15 to 5 grams wine extract per kg of product, most preferred from 0.25 to 3 gram wine extract per kg of product, wherein the wine extract is the fluid wine extract according to claim 1.

3. A food composition comprising 0.1 to 10 grams of wine extract per kg of product, more preferred from 0.15 to 5 grams wine extract per kg of product, most preferred from 0.25 to 3 gram wine extract per kg of product, wherein the wine extract is the fluid wine extract of claim 1.
